(19) United States
(12) Patent Application Publication
(10) Pub. No.: US 2020/0290858 A1
(43) Pub. Date: Sep. 17, 2020

(54) T-tube

(71) Applicant: Theodore Robert Regis, Brooklyn, NY (US)

(72) Inventor: Theodore Robert Regis, Brooklyn, NY (US)

(21) Appl. No.: 16/255,664

(22) Filed: Mar. 14, 2019

(51) Int. Cl. B67C 11/02

(52) U.S. Cl. CPC B67C 11/02; B67C 2011/20; B67C 2011/027

(57) ABSTRACT

T-Tube device is made to help oil changers, or adders applying the oil into an engine. It is a movement of adding oil to an engine safely. This device is attached on the quart (container's) mouth or neck. It is removable and attachable; from the neck the Tube runs going to the engine and transmits the liquid (oil) into the engine's body. This device operates easily with no oil dropping around the engine's neck, or around the engine's body of the vehicle. One end connects to the gallon (quart) or bottle's neck. T-TUBE eliminates the need of funnel and or spilling oil on or on the engine's body. It eliminates any increment weather, winds, or heat, hotness, coldness, or wet weather.

### PREAMBLES

A. Category of this invention deals with motor, engines, or any activity of employing lubricant.

B. Example of applying this device with the method of not wasting time or energy.

C. A category of speeding a process of movement by adding a solution using or employing a force or technique of adding oil into an engine.

D. A method of adding a liquid (oil) into another device while making the process easier.

E. Example of T-Tube comes with the same methodology.

F. The T-tube can screw (attached) to the quart's neck or around its neck able to transmit the oil into an engine.

G. A method of lubricant or adding oil into an engine thereon refers to any operating motor or engine.

### ELEMENTS

### IV

A. The method of claim 4 comprises further, a T-tube capable of stretching for transmitting liquid (oil) into an engine.

B. Inventor claimed not to use device for any other liquid except oil.

C. T-tube however is this invention created to use while supplying oil into an engine.

D. T-Tube is not made with another device it is therefore operating with another device such as a container (quart) or gallon or litter.

E. This device operating within the range of cars automobile or any other device operating machine capable of employing oil into an engine.

F. T-Tube neck plugged and attached to the device example quart, gallon while transmits the liquid into an apparatus.

### SPECIFIC CLAIMS ELEMENTS

A. T-tube has a thin tail plunging into an engine body receiving the oil.

B. A device inside a hollow conducting oil or liquid into the other device.

C. Object quart's cap with T-tube connects to the quarts or fabricates to fit around the neck of the quart or gallon.

D. Object comprises from claim I c and claim II B and claim III E.

E. As example, it is a length of 6 feet capable of reaching to a distance while using T-tube.

F. Minimum 3 feet in length, suggested inventor, and capable of stretching in 6 feet in length made with plastic or metal.

G. Prior to this, invention was never existed and patentability is original.

H. Invention claimed was never an existence on any form, or shape.

### Claim I

Element A: A lengthy device minimum three feet to maximum six feet long attached to a container elongated to an end to reach another apparatus.

Element B: A solid material capable of stretching transmitting liquid protective sheath to another apparatus.

Element C: A tube rest in the air by holding to surface adjacent to a motor transmitting a liquid.

### T-TUBE INVENTION SUMMARY

The T-Tube is, a device a longitude connected to the quart apparatus of claim of 1, transmits the oil liquid to an automotive engine when an engine requires oil or adding oil into a functional engine.

The T-Tube is a longitude connected to the quart apparatus of claim of 1, led singularity of passage of oil able to transmit the liquid oil, for example into an automotive engine when device requires additional oil.

The T-Tube is a longitude connected to the quart apparatus of claim of 1, singularity method of adding oil into an engine. Research proved by a large amount people nearly 90% spilled oil around their car engine when using funnel to add oil.

The spills of the oil smell, smoke caused dark fumes, caused engine fires and caused death to some instant. According to the Ocean pollution, 12% of ocean pollution is coming from oil spilled. Up to 92 million of gallons of oil have spilled into the ocean. Current invention will solve these problems.

The device T-Tube connected to a quart solves the problem of spilling oil around an engine motor. In fact, it solves any method of applying oil into any engine or apparatus.

1) A micro device called T-Tube comprises in one to work with a quart or gallon.

2) A small apparatus in the length of three feet-to-six feet in length.

3) Device capable of stretching to six feet long.

4) Able to stretch to its limit 6 feet long.

5) Inventor has recorded activity of the invention.

6) Device would build 100% plastic tube or metal.

7) Device will work by holding component to pour liquid into an engine.
Operating such a device brings newness to the way motorist's customers applied oil in their engines. The difference in relationship with the quarts that hold oil works while consumption the liquid in the other device (engine). Apparatus works by using the ½ motion using a hand movement while holding the quart.
a) The claim solves or eliminates the use of a funnel.
b) A device with using a parallel line or longitudinal
c) The body part is functional employing manual force
d) However, item patent is T-tube knowing as device that can help person employing a method of pour oil liquid into an apparatus smoothly
e) Device might be attached to the other apparatus such as quart, gallon, or litter
